(19) United States
(12) Patent Application Publication
(10) Pub. No.: US 2009/0087013 A1
(43) Pub. Date: Apr. 2, 2009

(54) RAY MAPPING

(75) Inventor: William A. Westrick, Fort Wayne, IN (US)

Correspondence Address: BAKER & DANIELS LLP, 300 NORTH MERIDIAN STREET, SUITE 2700, INDIANAPOLIS, IN, 46204, US

(73) Assignee: ZOOM Information Systems (The Mainz Group LL), Forty Wayne, IN (US)

(21) Appl. No.: 11/864,377

(22) Filed: Sep. 28, 2007

(51) Int. Cl. G06K 9/00

(52) U.S. Cl. 382/100

(57) ABSTRACT

The application discloses the use of light rays from a region and based on those light rays generates a map of the region.

### BACKGROUND AND SUMMARY OF THE INVENTION

The present invention relates generally to methods to analyze an image and, more particularly, to generate a ray map of a region being imaged.

It is known to use ray tracing wherein an environment is modeled and the path of light rays within the environment is traced. The present disclosure uses known light rays from a region and based on those light rays generates a map of the region.

According to an illustrative embodiment of the present disclosure, a method of generating a ray map for a first camera is provided. The method comprising the steps of: obtaining a digital image with the camera, the digital image; obtaining camera position information of the firs camera; and determining for a plurality of pixels in the digital image a direction vector based on the camera position information and region information. The ray map including the direction vector and the region information.

According to another illustrative embodiment of the present disclosure, a method of associating a plurality of rays with a point in a region is provided. The method comprising the steps of: for each of a plurality of images of the region obtaining camera position information for the camera taking the image and determining for a plurality of pixels in the digital image a direction vector based on the camera position information and region information. The region information including an intensity. The method further comprising the steps of determining intersecting direction vectors from multiple images which intersect at the point; and associating the intersecting direction vectors with the point.

According to a further illustrative embodiment of the present disclosure, a method of generating a virtual image of a region for a first position is provided. The method comprising the steps of: determining a ray map associated with the region including a plurality of rays, each ray including region information; determining a subset of the plurality of rays which are viewable from the first position; assigning the region information for each ray of the subset of plurality of rays to a corresponding location in the virtual image; and determining the region information for a remainder of the virtual image. The remainder of the virtual image corresponding to points in the region for which a known ray is not viewable from the first position.

According to yet another illustrative embodiment of the present disclosure, a computer readable medium including instructions to generate a virtual image of a region for a first position is provided. The computer readable medium comprising instructions to determine a ray map associated with the region including a plurality of rays, each ray including region information; instructions to determine a subset of the plurality of rays which are viewable from the first position; instructions to assign the region information for each ray of the subset of plurality of rays to a corresponding location in the virtual image; and instructions to determine the region information for a remainder of the virtual image, the remainder of the virtual image corresponding to points in the region for which a known ray is not viewable from the first position.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 is a two-dimensional representation of a plurality of camera views imaging a region;

FIG. 2 is a detail view of a portion of FIG. 1;

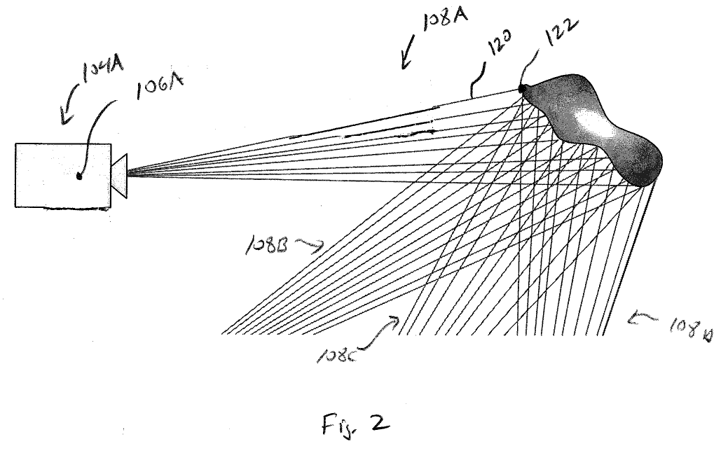

FIG. 3 is an exemplary method of generating a ray map which is associated with points in the region;

FIG. 4 is a two-dimensional representation of the use of ray mapping in the generation of a virtual image; and

FIG. 5 is a perspective view of a vehicle including a pair of cameras supported thereon.

Corresponding reference characters indicate corresponding parts throughout the several views. Although the drawings represent embodiments of the present invention, the drawings are not necessarily to scale and certain features may be exaggerated in order to better illustrate and explain the present invention.

### DETAILED DESCRIPTION OF THE DRAWINGS

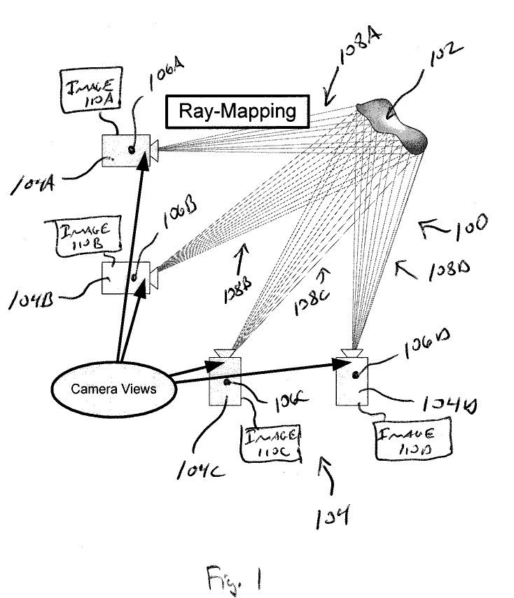

Referring to FIG. 1, a ray map 100 for a region 102 is represented. One or more cameras 104A-D obtain one or more images of region 102. In one embodiment, multiple stationary cameras are used. In one embodiment, a single camera or multiple cameras which are supported by a moveable vehicle are used. An exemplary moveable vehicle including two cameras mounted thereto is the GPSVISION mobile mapping system available from Lambda Tech International, Inc. located at 1410 Production Road, Fort Wayne, Ind. 46808. Although four cameras 140A-D are illustrated, a single camera 104 may be used and moved to the various locations. Further, the discussion related to one of the cameras, such as camera 104A, is applicable to the remaining cameras 140B-D.

Camera 104A is at a position 106A and receives a plurality of rays of light 108A which carry information regarding objects within region 102. As is known, light reflected or generated by objects in region 102 is received through a lens system of camera 104A and imaged on a detecting device to produce an image 110A having a plurality of pixels. A standard photographic image records a 2d array of data that represents the color and intensity of light entering the lens at different angles at a moment in time. This is a still image. Each pixel has region information regarding a portion of region 102, such as color and intensity.

A ray map for 108A corresponding to image 110A may be generated based on the region information of each pixel and the position 106A of camera 104A. In one embodiment, position 106A of camera 104 includes both the location and the direction of camera 104. Region 102 is within the viewing field of each of cameras 104A-D. By knowing the location and attitude of the camera 104A at the time the image 110A was taken then the color and intensity of the rays of light traveling to a known point has been captured.

Ray map 108A includes a plurality of ray vectors 120 which correspond to a plurality of respective points 122 of region 102 and the location of camera 104. Based on the position 106A of camera 104A the direction of vector 120 entering camera 104A from point 122 may be determined. A discussion of determining the position of point 122 is provided herein, but point 122 does lie on the ray defined by the pixel of image 110A associated with point 122 and the position 106A of camera 104A. The region information for the pixel in image 110A that corresponds to point 122 is associated with vector 120. As such, for each point 122 in region 102 for which a ray map is desired, a ray having an endpoint at the associated point 122, a direction defined by the associated vector 120, and color and intensity provided by the associated region information from image 110A may be determined. In one embodiment, not all pixels are included in the ray map.

In one embodiment, the location of points 122 is determined in the following manner. The ray vectors 122 from several of the ray maps are combined. For camera 104A, a given ray vector 120 passes through location 106A and has a direction based on position 106A and also passes through point 122, however the location of point 122 is not yet known. Another ray vector 120, associated with camera 104B, passes through location 106B and has a direction based on position 106B and also passes through point 122. Since both of these vectors pass through point 122, their intersection defines the position of point 122 in space. Additional ray vectors from other cameras 104 may also intersect these two ray vectors and thereby also define the location of point 122. As such, each point will have multiple rays 122 having associated region information associated therewith. In one embodiment, ray vectors 122 which intersect within a given tolerance specify the location of a point 122.

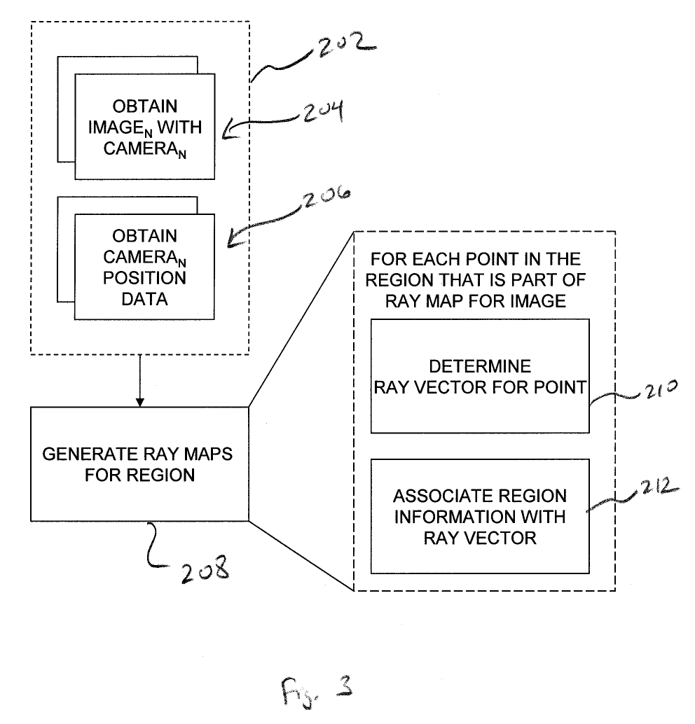

Referring to FIG. 3, an exemplary method 200 for generating one or more ray maps is shown. Method 200 may be embodied in one or more software programs having instructions to direct one or more computing devices to carry out method 200. Data regarding region 102 is collected, as represented by block 202. A plurality of images are obtained from one or more cameras, as represented by blocks 204. For each image, camera position data is obtained, as represented by blocks 206. Based on the obtained images and camera position data, one or more ray maps are generated, as represented by block 208.

In one embodiment, the one or more ray maps are generated for a plurality of desired points in the region. For each desired point in the region, a ray vector is determined for the point, as represented by block 210. The ray vector passes through the pixel in the respective image that contains point 122 and is in the direction defined by position 106A. Region information from the image regarding the desired point is associated with the ray vector, as represented by block 212. The ray maps 108 are maps for a given viewing position while ray map 100 is the overall ray map for region 102.

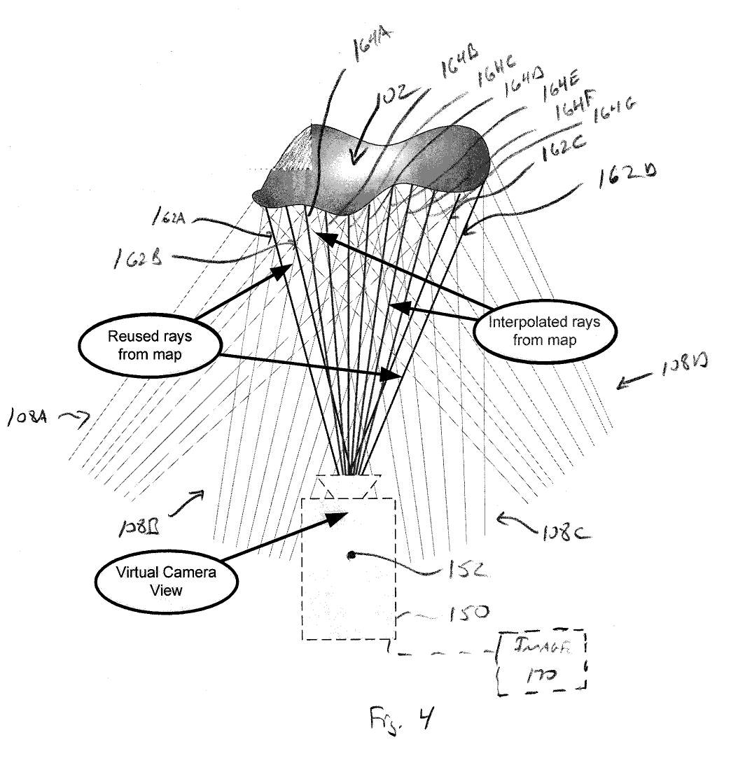

Referring to FIG. 4, one exemplary application of ray maps 108 is shown. As shown in FIG. 4, a virtual camera 150 is represented. Camera 150 is at a virtual position 152. Virtual position 152 includes both the location and the direction of camera 150. Based on virtual position 152 and by knowing the field of view of camera 150, a set of rays 162A-D from ray maps 108A-D which would enter the lens of camera 150 may be determined. These rays are indicated as reused rays from the map. Further, based on known rays from the maps 108, additional rays 164A-G may be determined. In one embodiment, the additional rays may be determined by selecting the nearest neighbor ray for point 122 that would fall within the viewing field of the virtual camera. In one embodiment, the additional rays are determined by a weighted average of a plurality of the nearest rays. As such, a virtual image 170 may be generated of region 102 for virtual camera 150. This virtual image 170 may be used to compare to an actual image from a camera located at position 152.

In one embodiment, an initial ray map is created for region 102. A mobile camera moves through an area wherein region 102 is imaged. The live images from the mobile camera are compared to virtual images for a camera determined based on the position of the mobile camera and the ray map. The mobile camera does not need to follow the exact path or take images at exactly the same place as the original cameras. The live and virtual images may be compared by a computing device and the differences highlighted. These differences may show changes in region 102, such as the addition of a section of a curb, the ground raked a different way, a pile of dirt, or other changes.

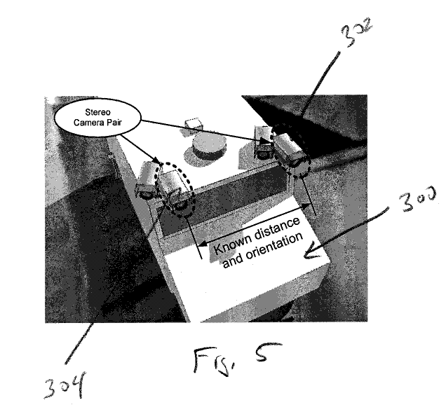

In one embodiment, the camera position 106 is calibrated as follows for a vehicle 300 (see FIG. 5) having a pair of cameras 302 and 304 supported thereby. Camera and lens calibration are used to achieve an accurate ray-map. Digital cameras do not linearly represent images across the imaging array. This is due to distortions caused by the lens, aperture and imaging element geometry as explained in David A. Forsyth, Jean Ponce ,“Computer vision: a modern approach” Prentice Hall, 2006. The camera is the primary instrument for determining the relative position of objects in region 102 to vehicle 300. A single image 110 may be used to determine the relative direction to the object 122, however two images 110 at a know distance and orientation are needed to determine the relative distance to the object 122. The cameras 302 and 304 that take these images 110 are known as a stereo pair. Since these cameras 302 and 304 are fixed to vehicle 300, their orientation and distance to each other may be measured very accurately.

An accurate position and orientation for each camera and sensor on the vehicle 300 must be determined and registered. The calibration of the mobile mapping system consists of camera calibration, camera relative orientation and the offset determination. The camera calibration is performed by an analytical method which includes: capturing images with different location and view angles of known control points in a test field, measuring the image coordinates and performing the computations to obtain camera parameters. The relative orientation and rotation offset are determined using constraints without ground control points.

### Camera Calibration

In one embodiment, the camera calibration processing is to determine camera parameters by a well-known bundle adjustment method. Cameras, whether metric, semi-metric or non-metric, do not possess a perfect lens system. To achieve high positioning accuracy, the lens distortions have to be corrected. For this purpose, six distortion parameters are used to correct the radial, decentering and affine distortions. The total camera parameters to be determined consist of the focal length, the principal point, and the lens distortion. The unknown camera parameters are determined using the known control points based on the co-linearity equation. Co-linearity equations are defined by:

$$\begin{matrix}\begin{matrix}x = {x}_{0} + d x - c \frac{N x}{N z} \\ y = {y}_{0} + d y - c \frac{N y}{N z}\end{matrix} \begin{matrix}\begin{matrix}with & \end{matrix} & \end{matrix} & ( 1 ) \\ \begin{matrix}N x = {r}_{11} ( X - {X}_{0} ) + {r}_{21} ( Y - {Y}_{0} ) + {r}_{31} ( Z - {Z}_{0} ) \\ N y = {r}_{12} ( X - {X}_{0} ) + {r}_{22} ( Y - {Y}_{0} ) + {r}_{32} ( Z - {Z}_{0} ) \\ N z = {r}_{13} ( X - {X}_{0} ) + {r}_{23} ( Y - {Y}_{0} ) + {r}_{33} ( Z - {Z}_{0} )\end{matrix} & ( 2 )\end{matrix}$$

In one embodiment with a least squares solution, the camera parameters, the position and rotation of every image may be computed using known control points.

### Camera Relative Orientation

For stereo camera system, two cameras are mounted on a stationary platform. This means that the relative relationship between two cameras is constant. The method to determine the relative orientation is using the co-planarity equation. This means that two conjugate image points and the two prospective centers are in one plane:

$$\vert \begin{matrix}{b}_{x} & {b}_{y} & {b}_{z} \\ u & v & w \\ {u}^{′} & {v}^{′} & {w}^{′}\end{matrix} \vert = 0 \qquad ( 3 )$$

where (u, v, w) and (u′, v′, w′) are the three dimensional image coordinates on left and right images and (bₓ, b_{y}, b_{z}) is the base vector between two cameras.

The five independent parameters, the x, y, and the three angular parameters, since the height of the camera is known, are the relative orientation parameters. At least 5 points are needed to solve the relative orientation parameter. For relative orientation, only image points are measured and used for determination, no control points are required. This method works as long as the parallax is large enough. This is true for the aero-photography, but in most stereo camera system, the base vector is limited and the parallax is small. This causes the very high correlation between the relative orientation parameters. To fix this problem, one method is to determine the relative orientation by applying the relative orientation constraints. It means that the same distance measured from two different image pairs should have the same value in the calibration procedure.

### Offset Calibration

The third calibration is to determine the position and orientation offset between the positioning system and the stereo cameras. This procedure may be conducted with or without known control points. The principal of the calibration is to determine the offset by using following conditions:
1) An object point located from different image pairs has an unique (X,Y,Z ) coordinate.
2) Different points in a vertical line has the unique (X,Y) coordinate
3) Different point in a horizontal plane has a unique (Z) coordinate.

X^{v}=Rᵣ^{v}(R_{b}^{r}Rₙ^{b}R_{c}ⁿ(X^{e}−Xᵢₙₛ^{e})−D_{rb}^{r}) (4)

The calibration procedure is based on the above positioning equation. Only three rotation offset and three position offset parameters are unknown. By measuring objects from different image pairs, the six offset parameters may be accurately determined. The positioning component provides the system position and orientation. After the system is calibrated, every object “seen” by two cameras may be precisely located in a global coordinate system.

The ray mapping concepts disclosed herein may be used with the methods disclosed in U.S. patent application Ser. No. (unknown), filed Sep. 28, 2007, Docket ZOOM-P0002, titled “PHOTOGRAMMETRIC NETWORKS FOR POSITIONAL ACCURACY,” the disclosure of which is expressly incorporated by reference herein.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains. Although the invention has been described in detail with reference to certain preferred embodiments, variations and modifications exist within the spirit and scope of the invention as described and defined in the following claims.

1. A method of generating a ray map for a first camera, including the steps of:
obtaining a digital image with the camera, the digital image;
obtaining camera position information of the firs camera;
determining for a plurality of pixels in the digital image a direction vector based on the camera position information and region information, the ray map including the direction vector and the region information.

2. A method of associating a plurality of rays with a point in a region, the method comprising the steps of:
for each of a plurality of images of the region
(a) obtaining camera position information for the camera taking the image; and
(b) determining for a plurality of pixels in the digital image a direction vector based on the camera position information and region information, the region information including an intensity
determining intersecting direction vectors from multiple images which intersect at the point; and
associating the intersecting direction vectors with the point.

3. A method of generating a virtual image of a region for a first position, the method comprising the steps of:
determining a ray map associated with the region including a plurality of rays, each ray including region information;
determining a subset of the plurality of rays which are viewable from the first position;
assigning the region information for each ray of the subset of plurality of rays to a corresponding location in the virtual image; and
determining the region information for a remainder of the virtual image, the remainder of the virtual image corresponding to points in the region for which a known ray is not viewable from the first position.

4. The method of claim 3, wherein the step of determining the region information for the remainder of the virtual image includes the step of assigning for each point in the remainder of the virtual image the region information of a ray associated with the point which is the nearest to being viewable from the first position.

5. The method of claim 3, wherein the step of determining the region information for the remainder of the virtual image includes the step of assigning for each point in the remainder of the virtual image a region information determined by a weighted average of a plurality of rays associated with the point.

6. A computer readable medium including instructions to generate a virtual image of a region for a first position, comprising:
instructions to determine a ray map associated with the region including a plurality of rays, each ray including region information;
instructions to determine a subset of the plurality of rays which are viewable from the first position;
instructions to assign the region information for each ray of the subset of plurality of rays to a corresponding location in the virtual image; and
instructions to determine the region information for a remainder of the virtual image, the remainder of the virtual image corresponding to points in the region for which a known ray is not viewable from the first position.

7. The computer readable medium of claim 6, wherein the instructions to determine the region information for the remainder of the virtual image includes instructions to assign for each point in the remainder of the virtual image the region information of a ray associated with the point which is the nearest to being viewable from the first position.

8. The computer readable medium of claim 6, wherein the instructions to determine the region information for the remainder of the virtual image includes instructions to assign for each point in the remainder of the virtual image a region information determined by a weighted average of a plurality of rays associated with the point.
